(19) United States
(12) Patent Application Publication
(10) Pub. No.: US 2011/0246678 A1
(43) Pub. Date: Oct. 6, 2011

(54) METHOD FOR AUTOMATIC MAPPING AND UPDATING OF COMPUTER SWITCHING DEVICES

(76) Inventors: Hung-June WU, Taipei Hsien (TW); Cheng-Sheng Chou, Taipei Hsien (TW)

(21) Appl. No.: 13/010,381

(22) Filed: Jan. 20, 2011

Related U.S. Application Data
(63) Continuation-in-part of application No. 12/749,878, filed on Mar. 30, 2010, now abandoned.

(51) Int. Cl. G06F 13/10

(52) U.S. Cl. 710/11

(57) ABSTRACT

The present invention relates to a method for automatic mapping and updating of computer switching devices, wherein the computer switching device is electrically connected with a plurality of peripheral devices and computers via a USB host MCU and a plurality of USB device MCUs that are connected. For non-standard USB devices or USB standard enumeration and parsing unable to be processed by built-in firmware, the USB host MCU transfers special requirements to a computer, receive and convert feedbacks, and transmit them to external peripheral devices to perform enumeration and connection processes and store them in the USB host MCU. For special communication requirements of computers, the USB device MCU performs a reverse process, and decides to map and update automatically to connect USB peripheral devices with computers successfully, thus increasing applicability of products, prolonging their service life and reducing consumption of resources for the benefit of environmental protection.

This application is a Continuation-In-Part of application Ser. No. 12/749,878, filed on Mar. 30, 2010, now pending. The patent application identified above is incorporated here by reference in its entirety to provide continuity of disclosure.

### BACKGROUND OF THE INVENTION

1. Field of the Invention

The present invention relates to a method for automatic mapping and updating of computer switching devices and more particularly, to the use of a USB host MCU and a plurality of USB device MCUs that are electrically connected to communicate with peripheral devices and a plurality of computers and to learn to store all processes and data by themselves, so as to enable standard and non-standard USB peripherals and computers of different kinds to be connected via computer switching devices, thus enhancing availability of these electronic products and prolonging their service life. Besides, with the self-learning function to compare and decide whether it is necessary to execute communication and enumeration processes, it will contribute to reducing error probability in program or data transfers and minimizing unnecessary resource waste.

2. Description of the Related Art

When a computer fails to meet the operational requirement due to working demands or upgradation, replacement with a new computer or continuing to use the old one is the most common solution. But under the situations of limited space or budgets, these ideas have hardly been realized over the past years. However, thanks to rapid developments of electronics and information technology, two or more computers, whether new or old, can share one keyboard, mouse, monitor and even one speaker, microphone and any other peripherals simply through connecting in series to a computer switch (KVM). In this way, users can not only gain more work space for improving work efficiency, but also reduce the costs for peripheral devices significantly.

The so-called computer switch (KVM) is a switch that integrates the keyboard, display and mouse. In other words, it allows users to switch among multiple computers by using one set of keyboard, video and mouse, simplifying operational devices in a multi-computer environment and enabling users to manage different computers or servers synchronously through rapid switching without interruption of operation of a working computer, thus making it easier to use computers.

FIGS. 12˜14 illustrate an Asynchronous/synchronous KVMP switch for console and peripheral devices capable of switching KVM channels and peripheral channels to common or different computers disclosed in U.S. Pat. No. 7,472,217. As illustrated, a signal switch A is connected to a CPU A1 and a USB hub switch module A2 through a USB device control module A3 for controlling signals. The USB device control module A3 comprises a USB device chip that is used in emulation operating devices (such as a keyboard or mouse) of a first output port A21, enabling a peripheral device D to switch from a first computer system B to a second computer system C or a different computer system, while a channel is maintained between the first computer system B and peripheral devices to ensure that a data flow between them is not interrupted. A CPU A1 comprises a first memory A11 that stores a management program A111 for managing operation of the signal switch A.

When it is necessary to connect the signal switch A with three or more peripheral devices D, however, one or more downstream hub E is needed to connect with a third output port A42 of the signal switch A for communicating with a master hub A41 in a USB host control module A4, or a USB hub comprising a console (not shown) is configured to connect with the mast hub A41 for increasing the number of connections between the third output port A42 and the peripheral devices D. Besides, when the peripheral devices D are connected, it is determined whether any of these connected devices meets the USB standards, enumerate each peripheral device D that meets the USB standards and parses any report data of such device. Controlling is recorded in a USB hub switch module A2. But unplugging or plugging peripheral devices D of downstream ports will result in resetting the host control RAM. As the emulation program of the whole system is built in a CPU chip (flash ROM or PROM), such program allows the signal switch A to emulate a computer and connect with the peripheral device D, thus enabling the signal switch A to communicate with USB devices or computers simultaneously.

According to this method, a plurality of channels is configured between the USB hub switch module A2 and the USB device control module A3 to solve the problem that transferred data flow is interrupted at time of switching between peripheral devices D, thus making transferring of data flows to be continued through the channels during switching between peripheral devices D. Yet, only a fixed number of peripheral devices D can be connected. If it is necessary to increase the number of the connected peripheral devices D, one or more downstream hubs E must be configured separately or embedded directly. This will lead to increases in costs. When connecting many downstream hubs E may not only require more space, but also cause inconvenience for use. More importantly, the signal switch A will determine whether the connected peripheral devices D comply with USB standards. Therefore, if peripheral devices D do not comply with USB standards, or if there is any problem or limitation on the emulation program of the signal switch A, these peripheral devices D will not be useful any longer.

Besides, the flow chart in U.S. Pat. No. 7,472,217 also shows clearly that the emulation program disclosed in the patent claims does not have the ability to learn by itself or map and update automatically when an unexecuted or non-standard peripheral device is connected. Nor does it have the mechanism to compare and discriminate by itself. In addition, when a peripheral device is plugged or unplugged, the signal switch is required to re-execute the emulation program embedded in the CPU chip, while the peripheral devices that cannot be processed are directly ignore and not connected.

US 2007/0300216 discloses an Information Processing Apparatus and Recording Medium Containing Program, wherein a plurality of computers and printers F are connected via local area network (LAN). The printer F includes a communication unit, which has an information comparing unit and is connected to a function information storage unit that stores the function information transmitted by the printer F. The information comparing unit compares a function identifier contained in the configuration information with the function identifiers contained in the function information, and then add the information items included in the configuration information that match those contained in the function identifiers. But the point of this method is: the computer stores the function information transmitted by the printer F via the function information storage unit, and uses the information comparing unit to compare and add the matched information items, so that the computer can use several printers and utilize all functions of each printer without installing drivers in the computer. The printers can communicate data with the computer only because they use a standard data transmission format. In addition, function identifiers are compared by using a computer in this method. Since the peripheral devices connected with a computer switching device are of different types, manufactured by different firms and have different applications, this technique is not only difficult to use in computer switching devices, but also leads to increase in power consumption during operation compared to updating and other tasking of the computer.

Therefore, there is a need to provide a method for automatic mapping and updating of computer switching devices that eliminates the drawbacks of the aforesaid prior art design.

### SUMMARY OF THE INVENTION

The present invention has been accomplished under the circumstances in view. It is the main object of the present invention to make the USB device MCU convert special demands from peripheral devices and make the USB host MCU transfer these demands to the computer, when the peripheral devices are non-standard USB devices or cannot be processed by built-in firmware programs, and to enable the response from the computer to be converted and transferred by USB device MCU and USB host MCU to the peripheral devices, so that the enumeration and connection processes are directly implemented between the peripheral devices and the computer, and are recorded and stored by USB host MCU one by one. When the computer has special communication demands, such processes are implemented in a reverse direction and recorded and stored by the USB device MCU one by one. Thus, every enumeration and connection process of a different computer system are recorded and stored in the corresponding USB device MCU. The enumeration and connection processes and data stored by a USB device MCU may somewhat differ, depending on the computer system to be connected, thus enabling standard and non-standard USB peripheral devices and different kinds of computer systems to be connected successfully through computer switching devices to increase applicability of electronic products, prolong their service life and further reduce consumption of resources for the purpose of environmental protection.

A secondary object of the present invention is to configure memory units with the storage function in USB host MCU and USB device MCU. When non-standard USB peripheral devices or computers with special requirements are plugged into computer switching devices, or communication requirements of special command data cannot be processed in USB host MCU, the processes of two-way communication and enumeration and special requirements and responses will be stored into memory units of MCU respectively, making it unnecessary to execute, record and store two-way communication and enumeration processes for the peripheral devices or computers any longer when they are plugged into computer switching devices again and compared to be the same. Besides, it allows the operation of comparison to be processed by USB host MCU and USB device MCU instead of computers originally. It can not only help to reduce the working power consumption of computers, but also help to drop the working power consumption of USB host MCU and USB device MCU. At the same time, it contributes to shortening the time required to connect peripheral devices and computers.

A further object of the present invention is to secure the communication and enumeration processes and response data stored by USB host MCU and USB device MCU to include all data of the peripheral devices or computers connected with the MCUs, allowing users to set any peripheral device or computer as an authorized device that can be connected or an unauthorized device that cannot be connected according to their needs and through different interface. Authorized data are stored in a permission area of a memory or memory unit, while unauthorized data are stored in a prohibited area of the memory or memory unit, so as to allow a comparison to be made by USB host MCU or USB device MCU when a peripheral device or computer is plugged. If the comparison result indicates authorization prohibited, the peripheral device will not be connected with the computer, thus preventing unauthorized persons from controlling the computer illegally via the peripheral device or from invading the whole system and destroy or stealing data via the computer for the purpose of enhanced safety and improved operating convenience.

### BRIEF DESCRIPTION OF THE DRAWINGS

FIG. 1 is a block diagram according to a preferred embodiment of the present invention.

FIG. 2 is a data block diagram according to a preferred embodiment of the present invention.

FIG. 3 is a block diagram according to another embodiment of the present invention.

FIG. 4 is a block diagram according to a further embodiment of the present invention.

FIG. 5 is a block diagram according to a further embodiment of the present invention.

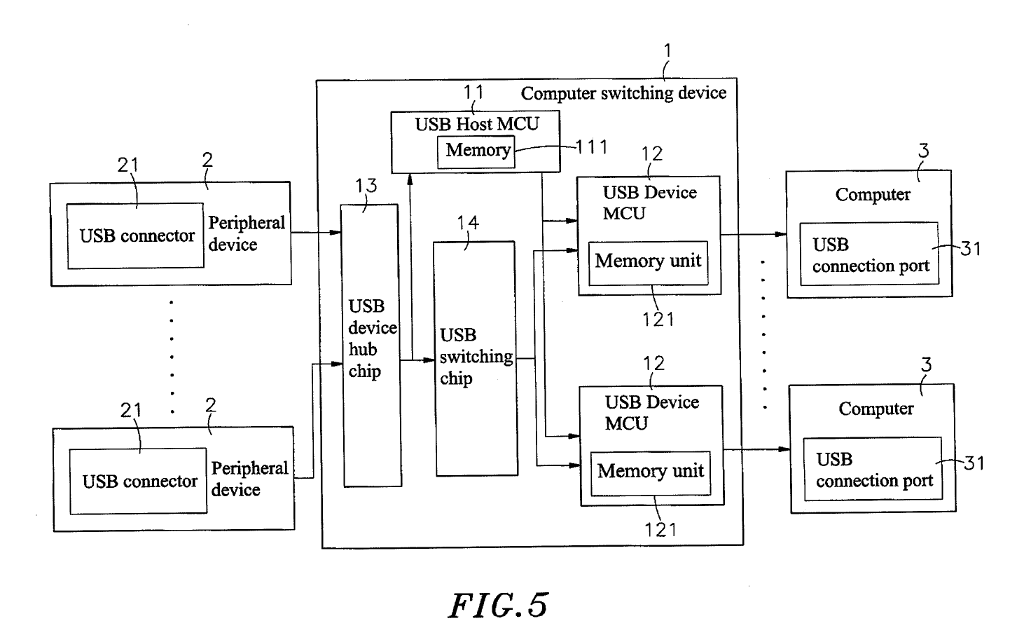

FIG. 6 is a flow chart illustrating processes of USB host MCU according to the present invention.

FIG. 7 is a flow chart illustrating processes of USB device MCU according to the present invention.

FIG. 8 is a flow chart illustrating processes of USB device MCU according to the present invention.

FIG. 9 is another flow chart illustrating processes of USB host MCU according to the present invention.

FIG. 10 is another flow chart illustrating processes of USB device MCU according to the present invention.

FIG. 11 is another flow chart illustrating processes of USB device MCU according to the present invention.

FIG. 12 is a block diagram according to a embodiment of the prior art.

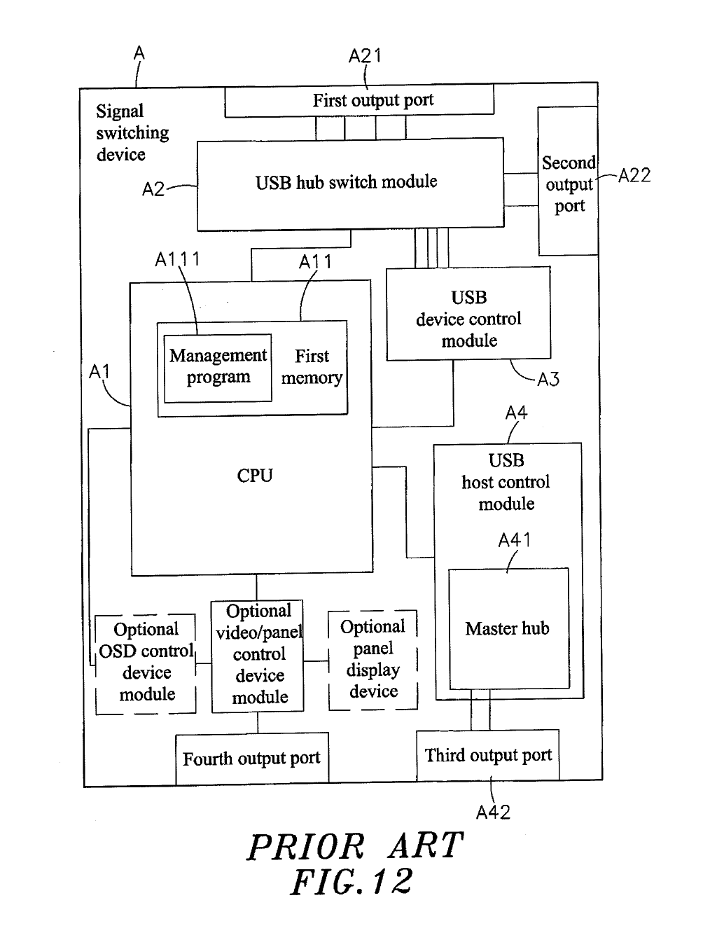

FIG. 13 is a schematic drawing illustrating an operation status of the computer switching device in accordance with the prior art.

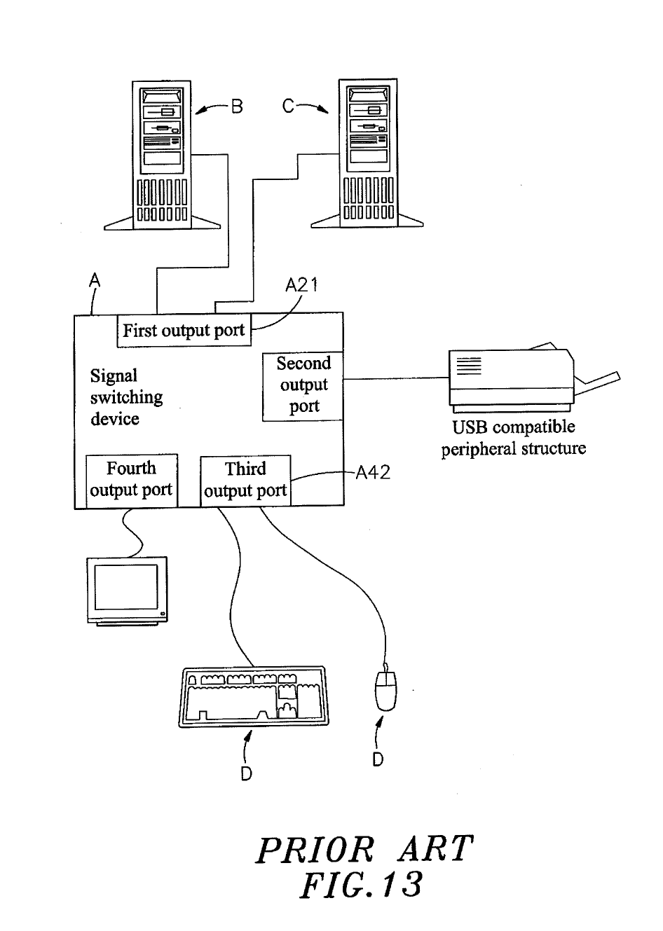

FIG. 14 is another schematic drawing illustrating an operation status of the computer switching device in accordance with the prior art.

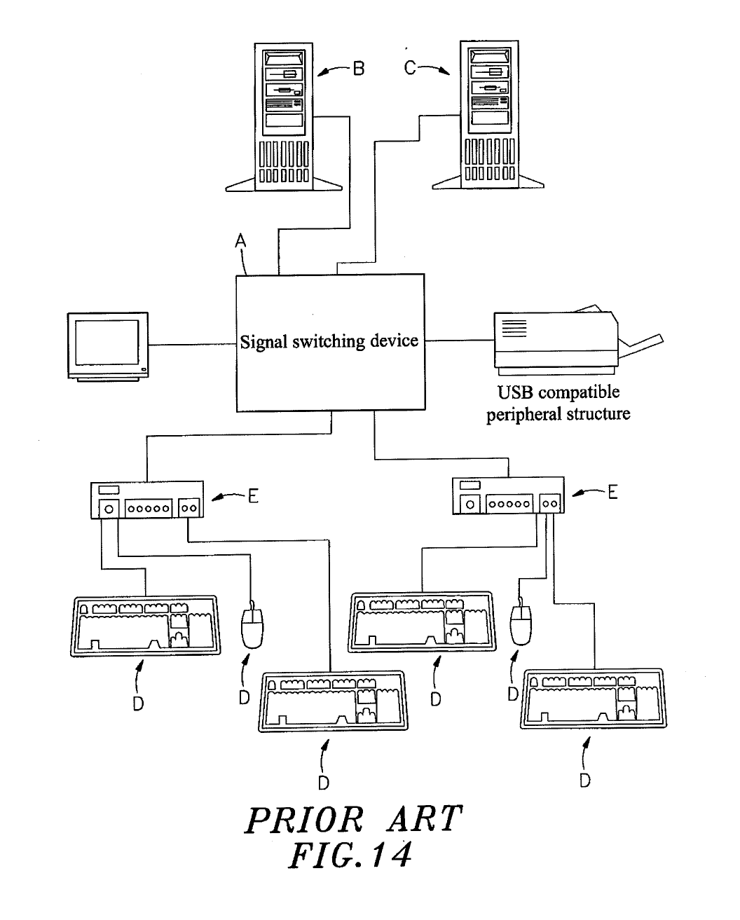

### DETAILED DESCRIPTION OF THE PREFERRED EMBODIMENT

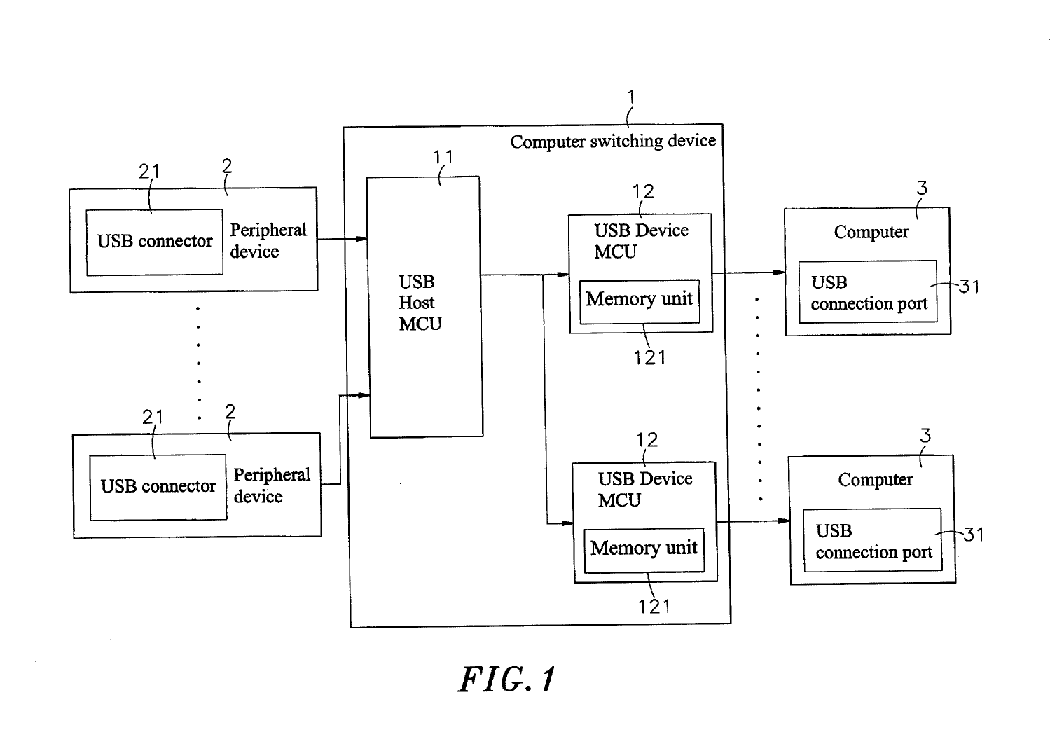

Referring to FIG. 1, which is a block diagram according to a preferred embodiment of the present invention. As shown clearly in this figure, a computer switching device 1 includes a USB host MCU 11 connected with a peripheral device 2 which contains a plurality of USB connectors 21, and the USB host MCU 11 is connected with a plurality of USB device MCU 12. The USB device MCU 12 are connected correspondingly with USB connection ports 31 of a plurality of computers 3.

When the computer switching device 1 is used, the USB host MCU 11 is stimulated as a host computer and communicates with the peripheral device 2 connected to the computer switching device 1 based on all standard USB communication protocols to read and store descriptors and necessary data including report analysis, enumeration, type or form, of the peripheral devices 2, wherein these descriptors include those of configuration, interface, class and endpoint. Then these necessary data are transmitted correspondingly to the USB device MCU 12 for storage, so that the computers 3 can acquire the accurate data of the peripheral device 2 through the USB device MCU 12 and enable the peripheral device 2 to perform the operations, achieving the effect of connecting the computers 3 with the peripheral device 2 directly. At the same time, no situation of incompatibility will occur between the peripheral devices 2 of different categories, types or functions (such as mouse, keyboard, joystick, touch screen, hub or other device with USB connection interface).

Additionally, the present invention has another function to study, map and update automatically by itself. When the USB host MCU 11 is connected with a non-standard or unexecuted external peripheral device 2, or the USB device MCU 12 is connected with a computer 3 with special communication requirements, the USB host MCU 11 and USB device MCU 12 transmit the communicated data directly to the peripheral device 2 or computer 3 connected with it, so that the peripheral device 2 and computer 3 implement enumeration and connection processes directly. And the USB host MCU 11 and USB device MCU 12 record and store the processes and data directly communicated and enumerated one by one. Therefore, any peripheral device 2 or computer 3, no matter how it is special, can be compatible with each other, and can record and store the processes and data needed by each other. Besides, when peripheral devices 2 or computers 3 of the same types or with special requirements are connected in the future, the USB host MCU 11 and USB device MCU 12 will directly execute enumeration and connection processes, thus reducing the power required for direct communication between peripheral devices 2 and computers 3, shortening the time of connection and reducing possibilities of error in program or data transfers.

If the computer switching device 1 re-boots or any peripheral device 2 is plugged in or pulled out, the USB host MCU 11 will communicate with the peripheral device 2 based on the standard USB communication protocol for reading and storing the necessary data again, and compare the new data with the old ones; if no differences are found, the USB device MCU 12 will not be updated; on the contrary, if any differences are found, it will map the new data into the USB device MCU 12 to update the connected computer 3. Thus, the computer 3 can know the data of the peripheral device 2 currently connected to the USB host MCU 11. In the case that the USB device MCU 12 is not connected to the computer 3 or the computer 3 is not started, after connecting or starting, the USB device MCU 12 will update the data of the peripheral device 2 into the computer 3 and enable the peripheral device 2 to perform the operations, without the problem of incompatibility.

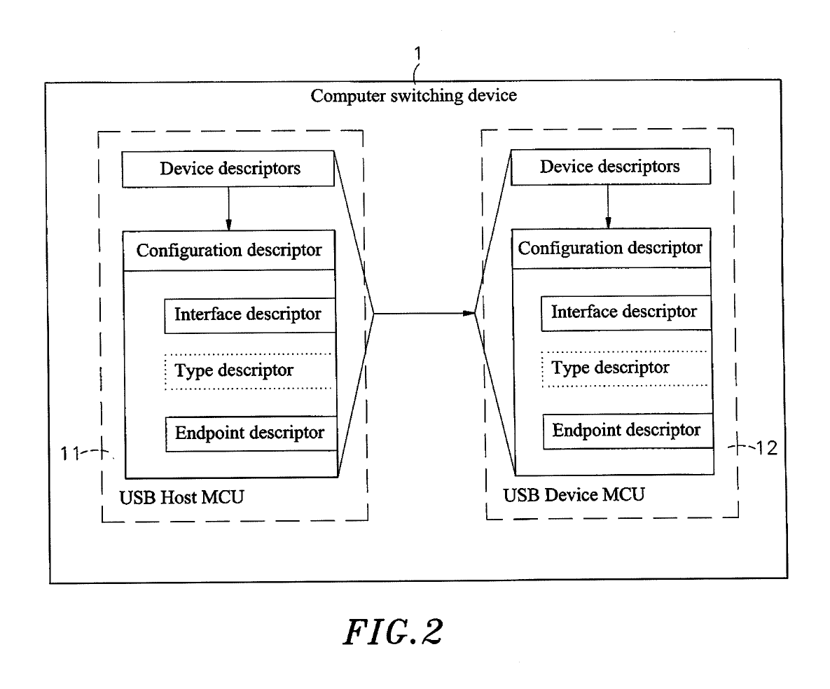

Referring to FIG. 2, which is a data block diagram according to a preferred embodiment of the present invention. As shown clearly in this figure, the necessary data of the USB host MCU 11 read by the peripheral devices 2 are correspondingly sent to the USB device MCU 12 through internal data transmission bus. The necessary data may be device descriptors comprising configuration descriptors, interface descriptors, type descriptors and endpoint descriptors.

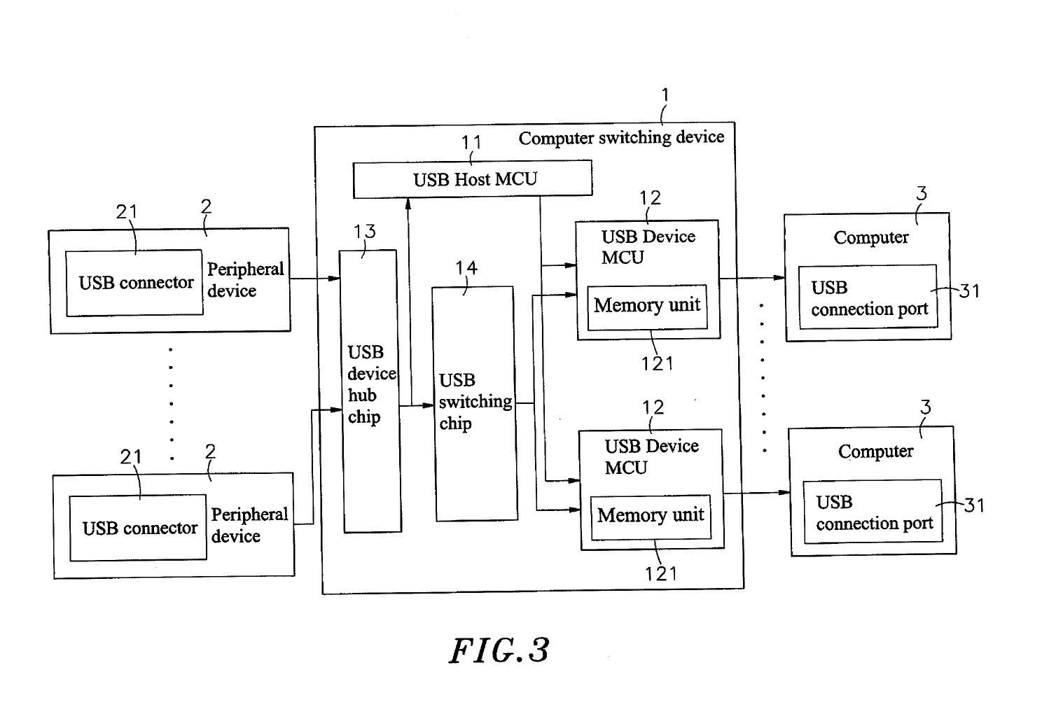

Refer to FIG. 3, which is a block diagram in accordance with another embodiment of the present invention. As shown clearly in the figure, the automatic mapping and updating computer switching device 1 includes a USB device hub chip 13 that can be connected with the plurality of peripheral devices 2, wherein the USB device hub chip 13 is connected electrically with the USB host MCU 11 and a USB switching chip 14, which are further connected electrically with the plurality of USB device MCU 12 respectively.

When the computer switching device 1 is connected to the peripheral devices 2 and the computers 3, first, connect one of those computers (which may be a computer started at the earliest or a specific computer) with the peripheral devices 2 directly to transmit data. The data of the peripheral devices 2 are transmitted through the USB device hub chip 13 to the USB switching chip 14 and further to a proposed USB device MCU 12, so that the computer 3 connected with the USB device MCU 12 perform the operations of the peripheral devices 2. Meanwhile, the USB host MCU 11 will carry out monitoring and recording operations to obtain and store report analysis, enumeration, type, form or other necessary data of the peripheral devices 2. Then, these necessary data of the peripheral devices 2 are transmitted to USB device MCU 12 for storage via the data bus without switching through a switching chip. Thus, after the USB device MCU 12 is connected to the computers 3, it will transmit the necessary data of the peripheral devices 2 to the connected computers 3 to ensure that all computers have these necessary data, achieving the objective of using the peripheral devices 2 to control the operations to the plurality of computers 3 successfully.

Depending on the computers 3 connected, the USB device MCU 12 can learn by itself to record and store different processes and data, thus making it compatible with all computers 3.

The USB host MCU 11 and the plurality of USB device MCU 12 can not only be installed on a circuit board inside the computer switching device 1, but also be configured to form an application specific integrated circuit (ASIC) or a commercial application integrated circuit inside a semiconductor chip for the purpose of reduced size of the MCUs and easy assembly. It is hereby stated that all other modifications and equivalent structural changes shall be included in the appended patent claims of the present invention.

With popularity of USB devices, such as mobile disks, external hard drives, music players, mobile phones, mice, keyboards and other electronic devices with USB connection ports, a plurality of USB devices connected with the computer switching device 1 can be plugged and removed frequently due to the plug-and-play characteristics of these USB devices. The USB host MCU 11 can store the report analysis, enumeration, type, form or other necessary data of the peripheral devices 2, and then transmits these necessary data to the USB device MCU 12 connected with the computers 3, making the USB device MCU 12 correspond to the computers 3 one to one for communication and storage, so that the computers 3 can receive the same necessary data of the peripheral devices 2. Thus, the problem of incompatibility due to insertion or removal of the peripheral devices 2 can be avoided. Moreover, since the USB device MCU 12 communicates and stores processes and data with the computers 3 connected correspondingly, and no breakdown, error or other problems will be caused due to incompatibility with the peripheral devices 2, people's willingness to use the computer switching device 1 is enhanced as a result.

The said computer switching device 1 may be a switch, an extender or a distributor, provided that it is capable of connecting the peripheral devices 2 with the computers 3. This is not intended to limit the patent claims of the present invention, and it is hereby stated that all other modifications and equivalent structural changes shall be included in the appended patent claims of the present invention.

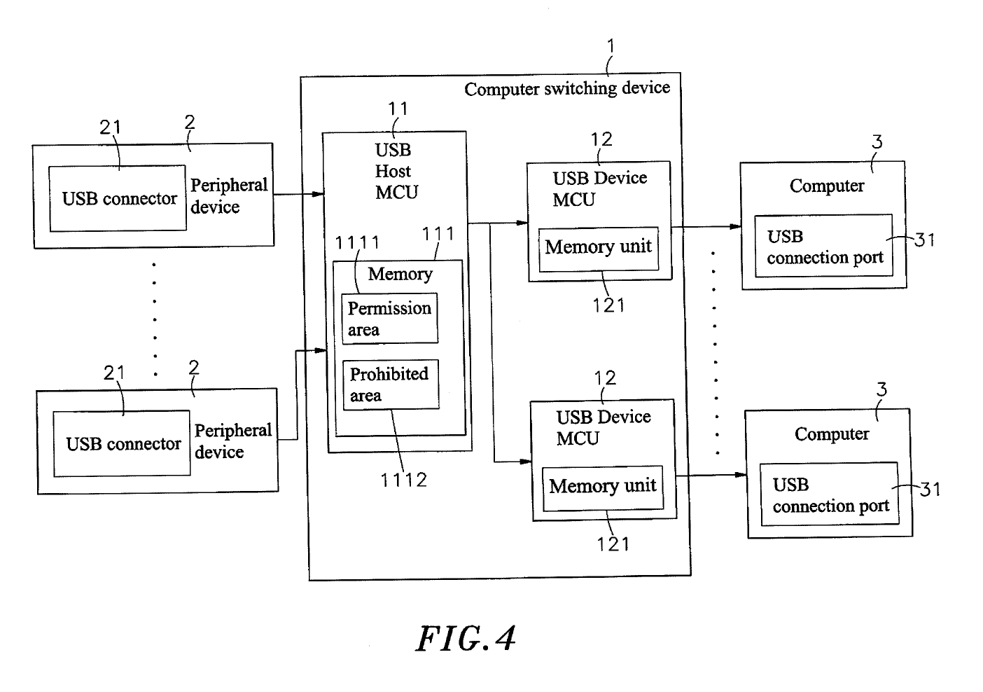

Refer to FIGS. 4˜5, which are block diagrams according to two other embodiments of the present invention. As shown clearly in both figures, the USB host MCU 11 contains a memory 111 which has a permission area 1111 and a prohibited area 1112, while the USB device MCU 12 includes a memory unit 121 which has a permission area 1211 and a prohibited area 1212. The USB host MCU 11 stores the necessary data of a proposed peripheral device 2 via the memory 111 to constitute the authorization conditions. After the peripheral device 2 is connected to the computer switching device 1, the USB host MCU 11 will read the necessary data of the peripheral device 2 or receive the necessary data from the USB device hub chip 13 at first, and compare these data with the necessary data that serve as the proposed authorization conditions in the memory 111. Through active control of authorization or passive control of non-authorization/inhibition, the USB host MCU 11 transmits the necessary data of the connected peripheral device 2 to the plurality of USB device MCU 12 when a specified peripheral device 2 is connected; and if an unspecified peripheral device 2 is connected, the USB host MCU 11 will not process or transmit the necessary data of this peripheral device 2. The USB device MCU 12 performs operations in the way that the aforesaid USB host MCU 11 does to achieve connection with the specified computer 3.

The necessary data stored in the aforesaid memory unit 121 and memory 111 as the proposed authorization conditions are device descriptors of the peripheral devices 2 or computer 3, which may be related to device class/device type, device brand, product name or model number, etc. to enable the peripheral devices 2 of a single type (e.g. keyboards) to be connected for use, or to limit the peripheral devices 2 of a specific brand or even a specific model to be connected. Since users utilize the peripheral devices 2 of a certain brand or model in most cases, such limitation will play a controlling role and help to prevent unauthorized persons from operating the computers 3 directly by using the peripheral devices 2, such as mice, keyboards or mobile memory devices. The necessary data stored in the memory units 121 as the proposed authorization conditions are device descriptors of the computer 3, which can prevent unauthorized access to the internal whole system through the computer 3 to destroy or steal data, thus achieving the purposes of enhanced safety and improved operating convenience.

Administrators may decide by themselves to set the proposed authorization conditions stored in the USB host MCU 11, USB device MCU 12, memory 111 or memory unit 121. They can conduct settings by using a specific high-safety programming interface, OSD (On-Screen-Display) operating interface embedded in the computer switching device 1 or hot keys on the keyboard. They may add or delete the device data stored in the permission area 1111 and 1211 or prohibited area 1112 and 1212 inside the memory 111 and memory units 121, or just replace the device data stored in the permission area with those stored in the prohibited area inside the memory 111 and memory units 121 directly. For settings via the specific programming interface, administrators need to write the data of a proposed peripheral device 2 or computer 3 onto the USB host MCU 11, USB device MCU 12, memory units 121 or memory 111 by using a firmware programming device or firmware programmer, and the proposed authorization conditions may a device type, device brand, product name or model number. Since the authorization conditions can only be changed in a special way, it prevents unauthorized persons from using the peripheral devices 2 or changing the authorization conditions, thus promoting the effect of safety and confidentiality. Moreover, it allows the proposed peripheral device 2 to be directly connected with the computer 3 when the proposed peripheral device 2 is first inserted into the computer switching device 1, thus making it more convenient to use computers and peripheral devices, in addition to reducing the power consumption of the USB host MCU 11 and USB device MCU 12 in the process of communicating, enumerating, recording and storing.

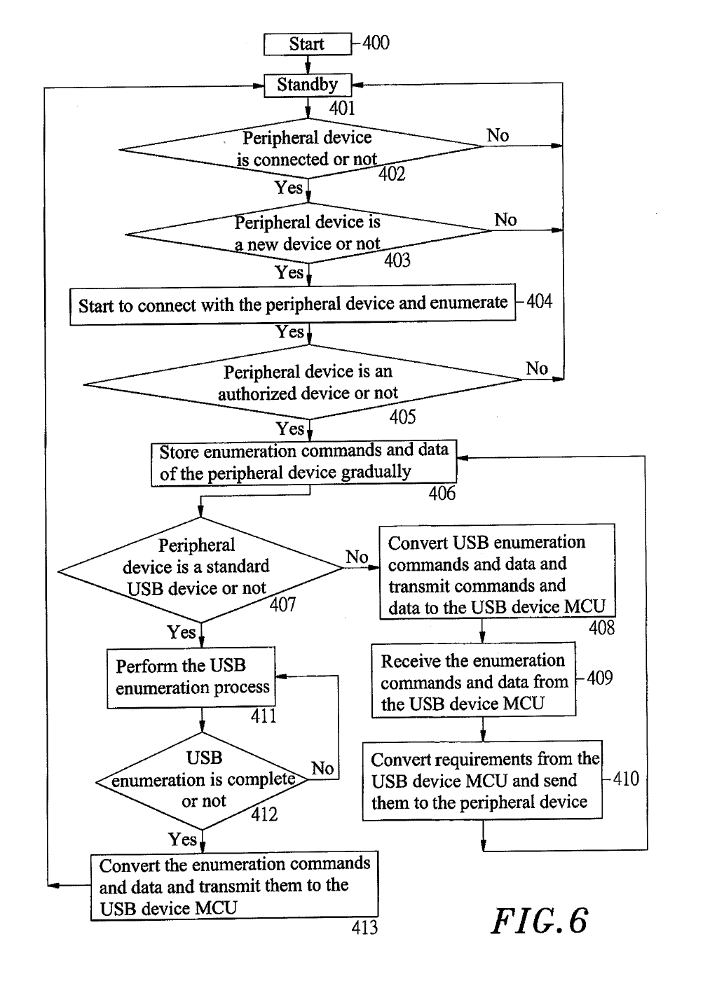

Refer to FIG. 6, which clearly shows that the working process of the USB host MCU 11 includes the following steps:

(400) Start.

(401) Standby.

(402) Peripheral device 2 is connected or not? If yes, proceed to step (403); if not, proceed to step (401).

(403) Peripheral device 2 is a new device or not? If yes, proceed to step (404); if not, proceed to step (401).

(404) Start to connect with the peripheral device 2 and enumerate.

(405) Peripheral device 2 is an authorized device or not? If yes, proceed to step (406); if not, proceed to step (401).

(406) Store enumeration commands and data of the peripheral device 2 gradually.

(407) Peripheral device 2 is a standard USB device or not? If yes, proceed to step (411); if not, proceed to step (408).

(408) Convert USB enumeration commands and data and transmit commands and data to the USB device MCU 12.

(409) Receive the enumeration commands and data from the USB device MCU 12.

(410) Convert requirements from the USB device MCU 12 and send them to the peripheral device 2, and then proceed to step (406).

(411) Perform the USB enumeration process.

(412) USB enumeration is complete or not? If yes, proceed to step (413); if not, proceed to step (411).

(413) Convert the enumeration commands and data and transmit them to the USB device MCU 12, then proceed to step (401).

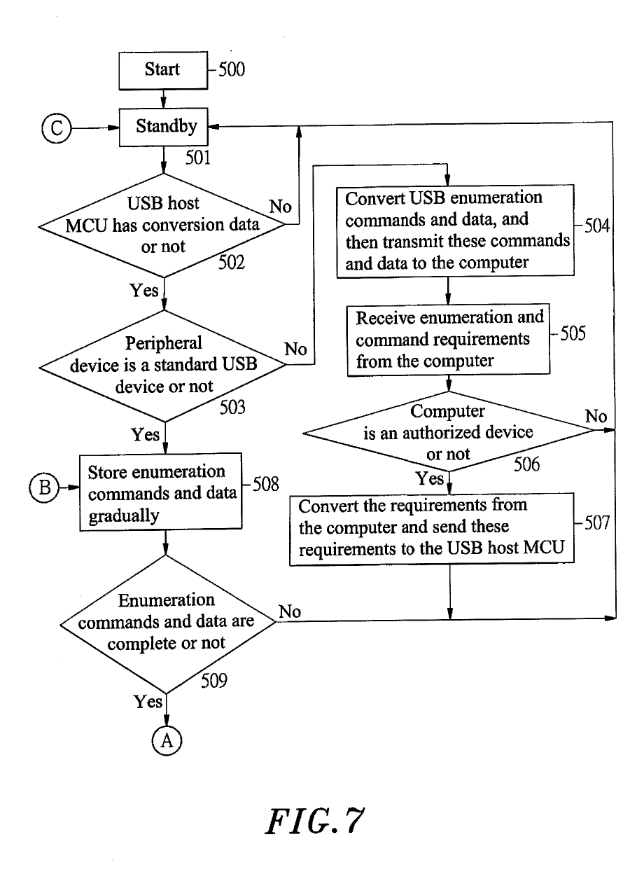

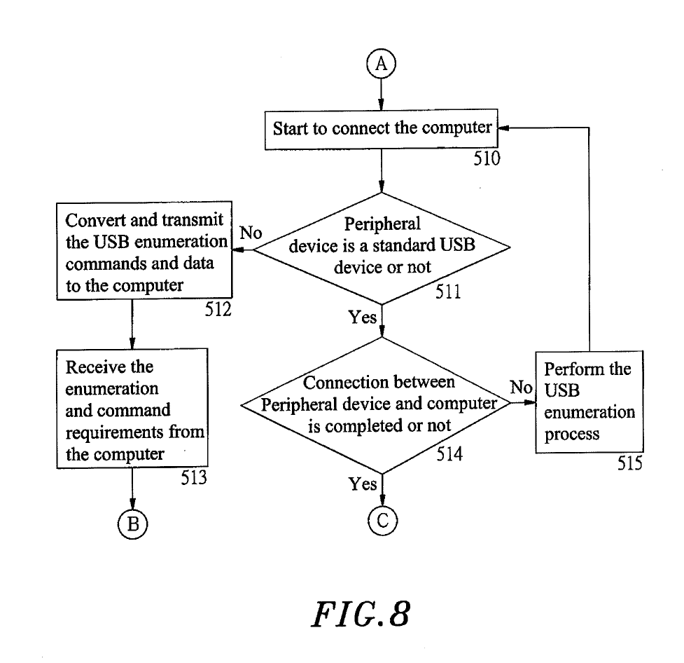

Refer to FIGS. 7 and 8, which clearly show that the working process of the USB device MCU 12 includes the following steps:

(500) Start.

(501) Standby.

(502) USB host MCU 11 has conversion data or not? If yes, proceed to step (503); if not, proceed to step (501).

(503) Peripheral device 2 is a standard USB device or not? If yes, proceed to step (508); if not, proceed to step (504).

(504) Convert USB enumeration commands and data, and then transmit these commands and data to the computer 3.

(505) Receive enumeration and command requirements from the computer 3.

(506) Computer 3 is an authorized device or not? If yes, proceed to step (507); if not, proceed to step (501).

(507) Convert the requirements from the computer 3 and send these requirements to the USB host MCU 11, and then proceed to step (501).

(508) Store enumeration commands and data gradually.

(509) Enumeration commands and data are complete or not? If yes, proceed to step (510); if not, proceed to step (501).

(510) Start to connect the computer 3.

(511) Peripheral device 2 is a standard USB device or not? If yes, proceed to step (514); if not, proceed to step (512).

(512) Convert and transmit the USB enumeration commands and data to the computer 3.

(513) Receive the enumeration and command requirements from the computer 3 and then proceed to step (508).

(514) Connection between Peripheral device 2 and computer 3 is completed or not? If yes, proceed to step (501); if not, proceed to step (515).

(515) Perform the USB enumeration process and then proceed to step (510).

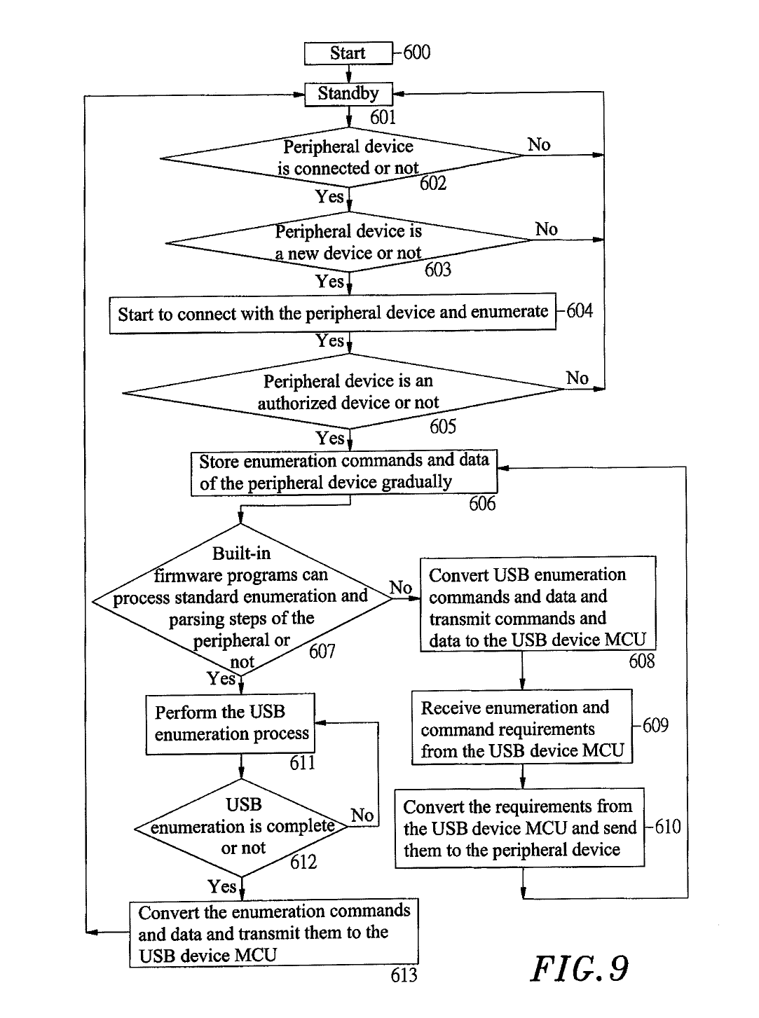

Refer to FIG. 9, which clearly shows that another working process of the USB host MCU 11 includes the following steps:

(600) Start.

(601) Standby.

(602) Peripheral device 2 is connected or not? If yes, proceed to step (603); if not, proceed to step (601).

(603) Peripheral device 2 is a new device or not? If yes, proceed to step (604); if not, proceed to step (601).

(604) Start to connect with the peripheral device 2 and enumerate.

(605) Peripheral device 2 is an authorized device or not? If yes, proceed to step (606); if not, proceed to step (601).

(606) Store enumeration commands and data of the peripheral device 2 gradually.

(607) Built-in firmware programs can process standard enumeration and parsing steps of the peripheral 2 or not? If yes, proceed to step (611); if not, proceed to step (608).

(608) Convert USB enumeration commands and data and transmit the commands and data to the USB device MCU 12.

(609) Receive enumeration and command requirements from the USB device MCU 12.

(610) Convert the requirements from the USB device MCU 12 and send them to the peripheral device 2, and then proceed to step (606).

(611) Perform the USB enumeration process.

(612) USB enumeration is complete or not? If yes, proceed to step (613); if not, proceed to step (611).

(613) Convert the enumeration commands and data and transmit them to the USB device MCU 12, then proceed to step (601).

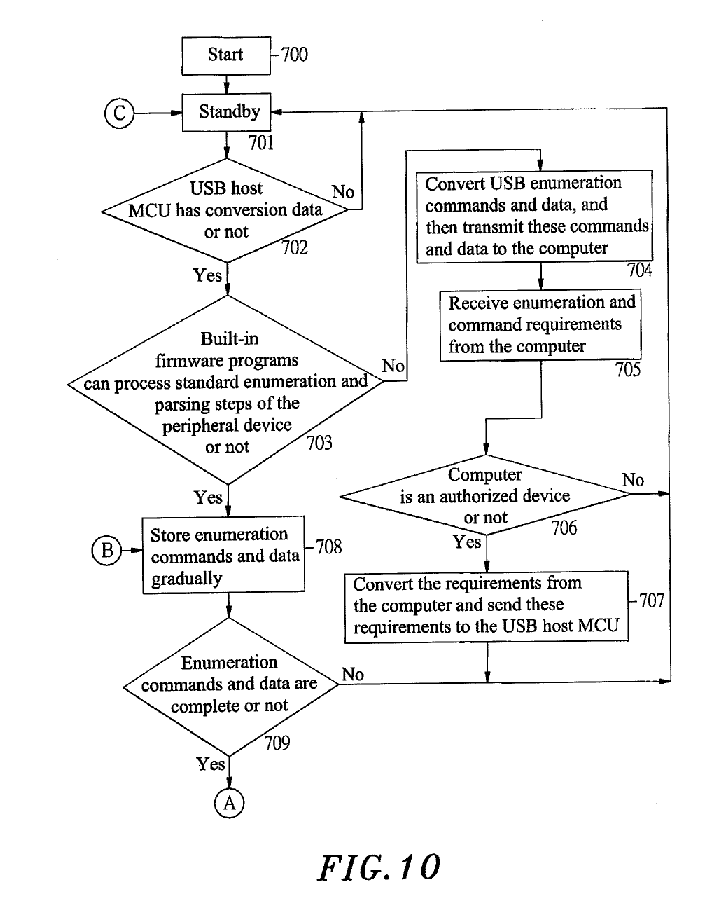

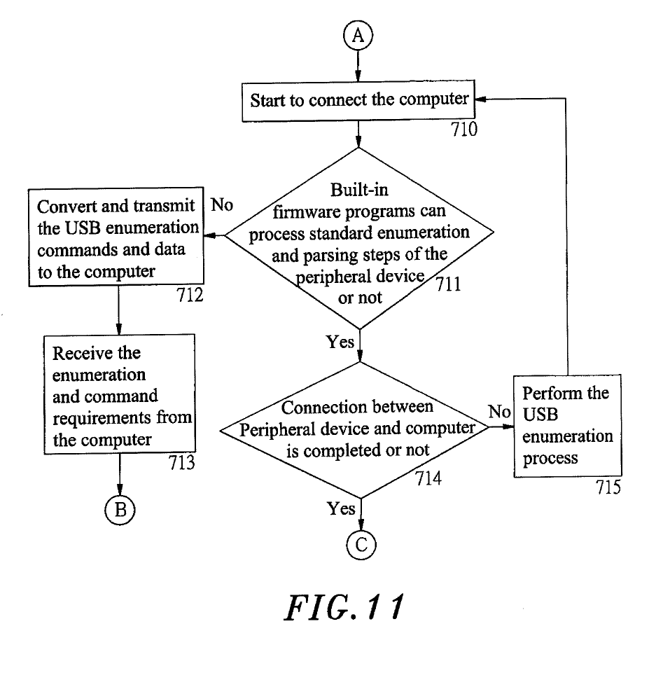

Refer to FIGS. 10 and 11, which clearly show that the working process of the USB device MCU 12 includes the following steps:

(700) Start.

(701) Standby. (702) USB host MCU 11 has conversion data or not? If yes, proceed to step (703); if not, proceed to step (701).

(703) Built-in firmware programs can process standard enumeration and parsing steps of the peripheral device 2 or not? If yes, proceed to step (708); if not, proceed to step (704).

(704) Convert USB enumeration commands and data, and then transmit these commands and data to the computer 3.

(705) Receive enumeration and command requirements from the computer 3.

(706) Computer 3 is an authorized device or not? If yes, proceed to step (707); if not, proceed to step (701).

(707) Convert the requirements from the computer 3 and send these requirements to the USB host MCU 11, and then proceed to step (701).

(708) Store enumeration commands and data gradually.

(709) Enumeration commands and data are complete or not? If yes, proceed to step (710); if not, proceed to step (701).

(710) Start to connect the computer 3.

(711) Built-in firmware programs can process standard enumeration and parsing steps of the peripheral device 2 or not? If yes, proceed to step (714); if not, proceed to step (712).

(712) Convert and transmit USB enumeration commands and data to the computer 3.

(713) Receive enumeration and command requirements from the computer 3 and then proceed to step (708).

(714) Connection between peripheral device 2 and computer 3 is completed or not? If yes, proceed to step (701); if not, proceed to step (715).

(715) Perform the USB enumeration process and then proceed to step (710).

Based on the above-mentioned processes of steps, when the peripheral device 2 has special parsing and enumeration steps, or special requirements for communicating commands and data that the USB host MCU 11 cannot process, making the peripheral device 2 unable to complete enumeration and connection according to standard USB protocols, the USB host MCU 11 will transmit the special requirements to the USB device MCU 12 after deciding that the peripheral device 2 is not a standard USB device or that the built-in firmware programs cannot process these requirements. The USB device MCU 12 will convert the special requirements, and then transfer these requirements to the computer 3. After receiving the response from the computer 3, the USB device MCU 12 will transmit the response to the USB host MCU 11, which will convert the response and further transmit it to the peripheral device 2, followed by enumerating and connecting processes. If the computer 3 has special parsing and enumerating processes or special requirements for communicating commands and data, these processes or requirements will be processed in a reverse direction. As mutually-communicated enumerating processes, special requirements and responses are stored in the memory 111 and memory unit 121 of the USB host MCU 11 and USB device MCU 12 store respectively, the USB host MCU 11 will record and store all response data and processes of special requirements necessary in the USB standard processes and steps of the peripheral device 2, while the USB device MCU 12 will record and store all response data required by the computer 3 in different or same processes and steps of communication and enumeration as a result of mutual communication.

The processes of communication and enumeration steps and response data stored by the USB host MCU 11 and USB device MCU 12 include all data of the connected peripheral device 2 or computer 3 (e.g. enumeration descriptor, configuration descriptor, device descriptor and endpoint descriptor, etc.). Therefore, based on their requirements for safe information management, users may select to set any peripheral device 2 or computer 3 as an authorized device that can be connected (active authorization) or as an unauthorized device that cannot be connected (passive inhibition), wherein the USB host MCU 11 stores the data of the authorized peripheral device 2 in the permission area 1111, while storing the data of the unauthorized peripheral device 2 in the prohibited area 1112. When another peripheral device 2 is connected, the USB host MCU 11 will compare the enumerated data of this connected peripheral device 2 with the authorization data stored in the memory. If the connected peripheral device 2 is identified as an authorized device according to comparison results, the USB host MCU 11 will implement follow-up steps of operations to connect the peripheral device 2 with the computer 3, so that users can operate. If the connected peripheral device 2 is considered as an unauthorized device according to comparison results, the USB host MCU 11 will communicate or transfer data with the USB device MCU 12. So this unauthorized peripheral device 2 will not be connected to the computer 3 and operated. The USB device MCU 12 stores the data of the authorized computer 3 in the permission area 1211, and stores those of the unauthorized computer 3 in the prohibited area 1212, and then makes comparison in the same way as the USB host MCU 11 does.

Based on the working process as indicated above, the USB host MCU 11 may decide whether the peripheral device 2 is an authorized device after steps (404), (411) or (412) are implemented. In a preferred embodiment of the present invention, it decides whether the peripheral device 2 is an authorized device after step (404) is implemented in order to skip the following steps of storage, transmission, communication and enumeration, so as to reduce resource consumption and shorten the processing time.

When conducting two-way communication and enumeration steps as well as recording and storage operations, the USB host MCU 11 and USB device MCU 12 experience complex processes and steps of processing and operating. The USB host MCU 11 will detect removal and insertion of the peripheral device 2, and compare the newly inserted peripheral device 2 with the previously inserted peripheral device 2 to decide whether the two devices are of the same type. If the comparison result shows that they are of the same type, the USB host MCU 11 will not transmit signals to notify the USB device MCU 12 of re-executing steps of communication and enumeration and recording and storage operations. Therefore, the USB host MCU 11 will execute steps of communication and enumeration and operations of recording and storage only when a new and different peripheral device 2 is inserted for connection, so as to reduce power consumption by the USB host MCU 11 and USB device MCU 12. Besides, the comparison operations that must be processed by the computer 3 originally will shift to the USB host MCU 11 and USB device MCU 12, thus reducing the power consumption of the computer 3.

Furthermore, the USB host MCU 11 and USB device MCU 12 are independent micro-process chips compatible with the peripheral devices 2 and various types of computer systems. Therefore, when the peripheral device 2 or computer 3 is replaced by a new one after the computer switching device is used for a long period of time, the computer switching device is still applicable to the new peripheral device 2 or computer 3, because it has the ability to learn by itself and compare and update automatically. By avoiding replacements of the computer switching device due to incompatibility, this can not only increase applicability of products and prolong the service life of products, but also achieve the purposes of reduced resource consumption and environmental protection.

Thus, the present invention relates to a method for automatic mapping and updating of computer switching devices, in which the USB host MCU 11 and a plurality of USB device MCU 12 connected with it mutually communicate with the peripheral device 2 and a plurality of computers 3. It enables the peripheral device and computers to mutually communicate and identify requirements before the process of enumeration and connection is executed, when the peripheral device 2 is a non-standard USB device that built-in firmware programs cannot process or the computer 3 has special communication requirements. By enabling standard and non-standard USB peripheral devices to be successfully connected with various types of computers via the computer switching device, it helps to increase applicability of products and prolong their service life.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A method for automatic mapping and updating of computer switching devices, wherein the computer switching device includes a USB host MCU and a plurality of USB device MCUs that are electrically connected with it; the USB host MCU is electrically connected with a plurality of peripheral devices which have USB connectors, and includes a memory; the plurality of the USB device MCUs are electrically connected with USB connection ports of a plurality of computers respectively, and each USB device MCU has a memory unit inside; the processing steps of the USB host MCU comprising:
(A01) Standby;
(A02) Peripheral device is connected or not? If yes, proceed to step (A03); if not, proceed to step (A01);
(A03) Peripheral device is a new device or not? If yes, proceed to step (A04); if not, proceed to step (A01);
(A04) Start to connect with the peripheral device and enumerate;
(A05) Store enumeration commands and data of the peripheral device gradually;
(A06) Peripheral device is a standard USB device or not? If yes, proceed to step (A10); if not, proceed to step (A07);
(A07) Convert USB enumeration commands and data and transmit commands and data to the USB device MCU;
(A08) Receive enumeration and command requirements from the USB device MCU;
(A09) Convert requirements from the USB device MCU and send them to the peripheral device, and then proceed to step (A05);
(A10) Execute the USB enumeration program;
(A11) USB enumeration is complete or not? If yes, proceed to step (A12); if not, proceed to step (A10); and
(A12) Convert enumeration commands and data and transmit them to the USB device MCU, then proceed to step (A01).

2. The method for automatic mapping and updating of computer switching devices according to claim 1, wherein the USB host MCU decides whether the peripheral device is an authorized device after starting to connect with the peripheral device and enumerate in step (A04)? If yes, proceed to step (A05); if not, proceed to step (A01).

3. A method for automatic mapping and updating of computer switching devices, wherein the computer switching device includes a USB host MCU and a plurality of USB device MCUs that are electrically connected with it; the USB host MCU is electrically connected with a plurality of peripheral devices which have USB connectors, and includes a memory; the plurality of the USB device MCUs are electrically connected with USB connection ports of a plurality of computers respectively, and each USB device MCU has a memory unit inside; the processing steps of the USB host MCU comprising:
(B01) Standby;
(B02) Peripheral device is connected or not? If yes, proceed to step (B03); if not, proceed to step (B01);
(B03) Peripheral device is a new device or not? If yes, proceed to step (B04); if not, proceed to step (B01);
(B04) Start to connect with the peripheral device and enumerate;
(B05) Store enumeration commands and data of the peripheral device gradually;
(B06) Built-in firmware programs can process standard enumeration and parsing steps of the peripheral device or not? If yes, proceed to step (B10); if not, proceed to step (B07);
(B07) Convert USB enumeration commands and data and transmit commands and data to the USB device MCU;
(B08) Receive enumeration and command requirements from the USB device MCU;
(B09) Convert requirements from the USB device MCU and send them to the peripheral device, and then proceed to step (B05);
(B10) Perform the USB enumeration process;
(B11) USB enumeration is complete or not? If yes, proceed to step (B12); if not, proceed to step (B10); and
(B12) Convert enumeration commands and data and transmit them to the USB device MCU, then proceed to step (B01).

4. The method for automatic mapping and updating of computer switching devices as claimed in claim 3, wherein the USB host MCU decides whether the peripheral device is an authorized device after starting to connect with the peripheral device and enumerate in step (B04)? If yes, proceed to step (B05); if not, proceed to step (B01).

5. A method for automatic mapping and updating of computer switching devices, wherein the computer switching device includes a USB host MCU and a plurality of USB device MCUs that are electrically connected with it; the USB host MCU is electrically connected with a plurality of peripheral devices which have USB connectors, and includes a memory inside; the plurality of the USB device MCUs are electrically connected with USB connection ports of a plurality of computers respectively, and each USB device MCU has a memory unit inside; the processing steps of the USB device MCU comprising:
(C01) Standby;
(C02) USB host MCU has conversion data or not? If yes, proceed to step (C03); if not, proceed to step (C01);
(C03) Peripheral device is a standard USB device or not? If yes, proceed to step (C07); if not, proceed to step (C04);
(C04) Convert USB enumeration commands and data, and then transmit these commands and data to the computer;
(C05) Receive enumeration and command requirements from the computer;
(C06) Convert requirements from the computer and send these requirements to the USB host MCU and then proceed to step (C01);
(C07) Store enumeration commands and data gradually;
(C08) Enumeration commands and data are complete or not? If yes, proceed to step (C09); if not, proceed to step (C01);
(C09) Start to connect the computer;
(C10) Peripheral device is a standard USB device or not? If yes, proceed to step (C13); if not, proceed to step (C11);
(C11) Convert and transmit the USB enumeration commands and data to the computer;
(C12) Receive enumeration and command requirements from the computer and then proceed to step (C07);
(C13) Connection between peripheral device and computer is completed or not? If yes, proceed to step (C01); if not, proceed to step (C14); and
(C14) Perform USB enumeration process and then proceed to step (C09).

6. The method for automatic mapping and updating of computer switching devices as claimed in claim 5, wherein the USB device MCU decides whether the computer is an authorized device after receiving enumeration and command requirements from the computer in step (C05)? If yes, proceed to step (C06); if not, proceed to step (C01).

7. A method for automatic mapping and updating of computer switching devices, wherein the computer switching device includes a USB host MCU and a plurality of USB device MCUs that are electrically connected with it; the USB host MCU is electrically connected with a plurality of peripheral devices which have USB connectors, and includes a memory inside; the plurality of the USB device MCUs are electrically connected with USB connection ports of a plurality of computers respectively, and each USB device MCU has a memory unit inside; the processing steps of the USB device MCU comprising:
(D01) Standby;
(D02) USB host MCU has conversion data or not? If yes, proceed to step (D03); if not, proceed to step (D01);
(D03) Built-in firmware programs can process standard enumeration and parsing steps of the peripheral device or not? If yes, proceed to step (D07); if not, proceed to step (D04);
(D04) Convert USB enumeration commands and data, and then transmit these commands and data to the computer;
(D05) Receive enumeration and command requirements from the computer;
(D06) Convert requirements from the computer and send these requirements to the USB host MCU, and then proceed to step (D01);
(D07) Store enumeration commands and data gradually;
(D08) Enumeration commands and data are complete or not? If yes, proceed to step (D09); if not, proceed to step (D01);
(D09) Start to connect the computer;
(D10) Built-in firmware programs can process standard enumeration and parsing steps of the peripheral device or not? If yes, proceed to step (D13); if not, proceed to step (D11);
(D11) Convert and transmit USB enumeration commands and data to the computer;
(D12) Receive enumeration and command requirements from the computer and then proceed to step (D07);
(D13) Connection between peripheral device and computer is completed or not? If yes, proceed to step (D01); if not, proceed to step (D14); and
(D14) Perform the USB enumeration process and then proceed to step (D09).

8. The method for automatic mapping and updating of computer switching devices as claimed in claim 7, wherein the USB device MCU decides whether the computer is an authorized device after receiving enumeration and command requirements from the computer in step (D05)? If yes, proceed to step (D06); if not, proceed to step (D01).
